(19) United States
(12) Patent Application Publication
(10) Pub. No.: US 2004/0080184 A1
(43) Pub. Date: Apr. 29, 2004

(54) Seal for an automobile optical unit

(76) Inventor: Thierry Fleurence, Bobigny Cedex (FR)

Correspondence Address: MORGAN & FINNEGAN, L.L.P., 345 PARK AVENUE, NEW YORK, NY, 10154, US

(21) Appl. No.: 10/688,381

(22) Filed: Oct. 16, 2003

(30) Foreign Application Priority Data
Oct. 18, 2002 (FR) 0213335

(51) Int. Cl. B60J 7/00

(52) U.S. Cl. 296/193.04; 296/193.01; 296/901.01

(57) ABSTRACT

The present invention concerns a seal for an optical unit constituting an automobile indicating or illuminating light, intended to be mounted between this optical unit (1) and a support (6) in which it is inserted, the seal consisting of a sheet of flexible material provided with an internal orifice (12) intended to receive the unit.

According to the invention, the seal consists of at least one material with a self-adhesive surface skin formed by extrusion.

### FIELD OF THE INVENTION

The present invention relates to a seal for an optical unit constituting an automobile signalling or illuminating light.

### BACKGROUND OF THE INVENTION

An optical unit 1 of this type is depicted in FIG. 1, installed on a vehicle. It is mounted on the bodywork of the vehicle 6 by insertion in an opening 4 arranged therein, so that the signalling or illumination light is directed towards the outside of the vehicle. A seal 5 is interposed between the unit 1 and the bodywork 6. The optical unit 1 is screwed or snapped onto the bodywork 6.

Currently this seal can be produced in the following ways.

It can consist of a cylindrical foam bead possibly precoated with adhesive and fixed all around the optical unit. This embodiment takes a long time to install and lacks reliability.

It may consist of a foam sheet cut to a size greater than that of the opening in the bodywork and cut with an internal orifice in order to form a frame.

The foam used in this case is cellular and presents problems of impermeability, water being able to be introduced and stagnate in these cells.

Moreover, this type of seal also poses problems of impermeability because of the lack of flexibility of the foam which is difficult to compress sufficiently when the optical unit is screwed or snapped on.

The invention resolves these problems by proposing a seal for an optical unit constituting an automobile indicator or illuminating light, rapid and reliable to manufacture and with excellent sealing quality.

### SUMMARY OF INVENTION

For this purpose, the invention concerns a seal for an optical unit constituting an automobile signalling or illuminating light, intended to be mounted between this optical unit and a support in which it is inserted, the seal consisting of a sheet of flexible material provided with an internal orifice intended to receive the unit, characterised in that it consists of at least one material with a self-adhesive surface skin formed by extrusion, the seal comprising, on at least one of its edges, at least one lip with a height greater than the thickness of the sheet and perpendicular thereto.

The invention has several advantages.

The method of manufacture by extrusion is a rapid and reliable method.

It also makes it possible to produce, from cellular material, a surface skin which provides an excellent seal, this skin forming a barrage against moisture. In addition, by extrusion, it is possible to obtain a particularly flexible and compressible seal.

The lip of the seal, which is very easily produced during extrusion, improves the seal still further.

This is because the seal must adapt as closely as possible to the space between the optical unit and the bodywork. However, this may prove difficult for several reasons. First of all, the bodywork may have a non-flat or curved shape at this point. Next, it must take account of differences in geometry between the optical unit and the bodywork at this point. Finally, tolerance ranges are to be considered, especially when the optical unit is snapped onto the bodywork, this snapping on providing lesser clamping than screwing and having to be compensated for in order to obtain correct compression of the seal in order to obtain acceptable sealing.

The lip resolves these various problems by providing a protrusion at the point of the compression of the seal against the bodywork which adapts to the shape of the bodywork and the optical unit, compensates for the differences in tolerance and provides maximum compression.

Advantageously, the seal according to the invention consists of various coextruded materials with different hardnesses.

Extrusion makes it possible to produce such a seal in different materials with different hardnesses by coextrusion in the direction of travel of the extrusion. Thus a more flexible part may be produced at the lip, for example.

It preferably consists at least partially of cellular EPDM.

The invention also concerns a method of manufacturing a seal, characterised in that it consists of producing a strip by extrusion, cutting it into sheets with a dimension equal to that of the seal and cutting out the said internal orifice.

By this method, there is obtained a seal of better strength, simplified installation accordingly and facilitating the possible placing of a bonding adhesive on the optical unit.

The cutting into sheets and the cutting of the said orifice are preferably simultaneous.

The invention is described below in more detail with the help of a figure representing only one preferred embodiment of the invention.

### BRIEF DESCRIPTION OF THE DRAWINGS

FIG. 1, already dealt with, depicts an optical unit mounted on a vehicle body.

FIG. 2 is a perspective view of a seal according to the invention in an intermediate step of its manufacture.

FIG. 3 is a perspective view of a seal according to the invention.

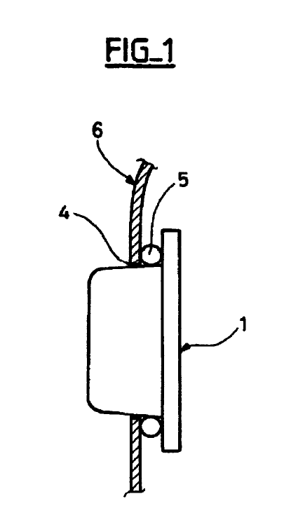

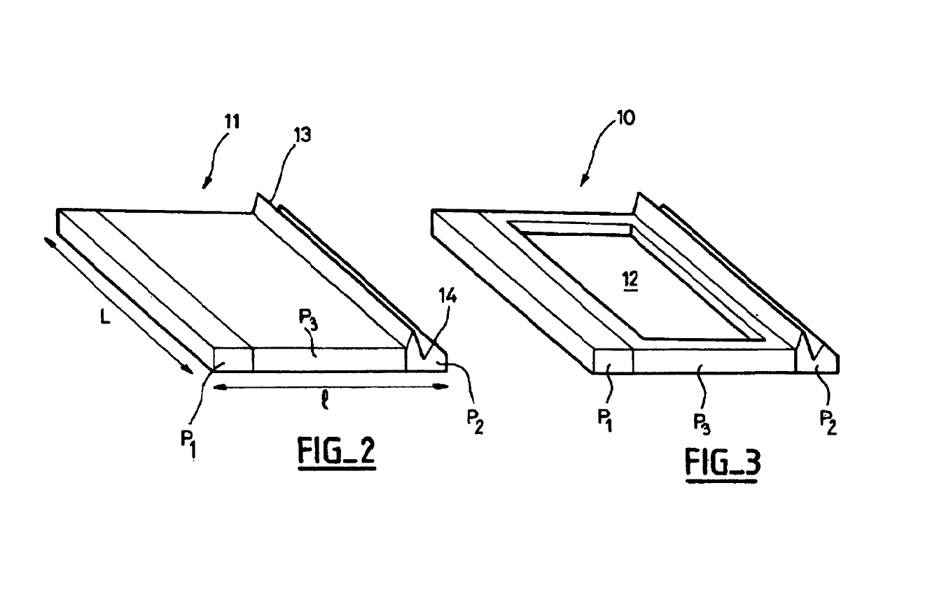

### DESCRIPTION OF THE PREFERRED EMBODIMENTS

By extrusion there is produced a strip of material with a self-adhesive surface skin formed by extrusion, preferably from cellular EPDM, and this strip is cut into sheets 11 with a size equal to that of the seal. According to the embodiment described, the extrusion width 1 of the strip corresponds to the width of the seal and the length L of the sheets 11 cut to the length of the seal, that is to say the dimension which will be substantially horizontal once the seal is mounted on the bodywork.

In order to obtain the seal 10 according to the invention, an internal orifice 12 intended to receive the optical unit is then cut out.

In order to optimise this method, preferably, the cutting into sheets 11 and the cutting of the orifice 12 may be simultaneous.

Advantageously, during extrusion, there is produced on at least one of the edges of the strip a lip 13 with a height greater than the thickness of the strip and perpendicular thereto.

According to the embodiment depicted, this lip 13 is produced on the top side of the seal, once the optical unit is mounted on the bodywork.

Several parallel lips 13, 14 with different heights can be produced, in the example depicted they are two in number.

An asymmetric arrangement of this type gives rise, when the optical unit is mounted on the bodywork, to a compression and a greater reaction on the edge equipped with the lips 13, 14. Thus a tilting of the optical unit is produced during mounting, allowing take up of play at the opposite edge.

Advantageously, the seal 10 consists of various coextruded materials with different hardnesses.

According to the embodiment depicted, it consists of two materials. One, more flexible, constitutes the edge parts P1, P2 in the direction of extrusion, a part P2 comprising the lips 13, 14 and the other harder part the central part P3 of the seal 10.

What is claimed is:

1. Seal for an optical unit constituting an automobile indicator or illuminating light, intended to be mounted between this optical unit and a support in which it is inserted, the seal consisting of a sheet of flexible material provided with an internal orifice intended to receive the unit, wherein it consists of at least one material with a self-surface skin formed by extrusion, the seal comprising, on at least one of its edges, at least one lip with a height greater than the thickness of the sheet and perpendicular thereto.

2. Seal according to claim 1, which consists of various coextruded materials with different hardnesses.

3. Seal according to claim 1, which consists at least partially of cellular EPDM.

4. Method of manufacturing a seal according to claim 1, which method consists of producing a strip by extrusion, cutting it into sheets with a dimension equal to that of the seal and cutting out the said internal orifice.

5. Method according to claim 4, wherein the cutting into sheets and the cutting of the said orifice are simultaneous.
